(19) United States
(12) Patent Application Publication
(10) Pub. No.: US 2014/0028117 A1
(43) Pub. Date: Jan. 30, 2014

(54) CHAOTIC VIBRATION ENERGY HARVESTER AND METHOD FOR CONTROLLING SAME

(71) Applicant: Vytautas Bucinskas, Vilnius (LT)

(72) Inventor: Vytautas Bucinskas, Vilnius (LT)

(21) Appl. No.: 13/560,983

(22) Filed: Jul. 27, 2012

(51) Int. Cl. H02K 44/18

(52) U.S. Cl. 310/11

(57) ABSTRACT

A chaotic vibration energy harvester includes a body forming a fluid chamber. At least one coil surrounds at least a portion of the fluid chamber. A ferromagnetic fluid is located within the fluid chamber. The ferromagnetic fluid occupies less than an entirety of the fluid chamber such that the ferromagnetic fluid forms a free floating mass that moves within the fluid chamber relative to the at least one coil. Movement of the body causes movement of the mass of ferromagnetic fluid relative to the at least one coil, which changes magnetic flux within a volume surrounded by the at least one coil and induces a current in the at least one coil.

### STATEMENT OF INCORPORATION BY REFERENCE

This application is related to U.S. patent application Ser. No. (not yet assigned), Docket No. 1896/2, entitled “ENERGY HARVESTING SHOCK ABSORBER AND METHOD FOR CONTROLLING SAME” filed on even date herewith, the disclosure of which is incorporated herein by reference in its entirety.

### TECHNICAL FIELD

The subject matter described herein relates to harvesting vibrational energy. More particularly, the subject matter described herein relates to a chaotic vibration energy harvester and a method for controlling such a harvester.

### BACKGROUND

Vibrational energy is kinetic energy that is created when an object moves. Technical equipment, transportation devices, and the human body all produce vibrational energy when moving. The amount of vibrational energy produced by an individual object, such as the human body or an automobile seat, is typically small. However, the wide availability of vibrational sources makes vibrational energy an attractive target for energy harvesting.

Vibrational energy harvesting involves converting vibrational energy into electrical energy. Vibrational energy harvesters typically include a permanent magnet and a coil, where moving of the magnet with respect to the coil changes the magnetic flux in the coil and induces a current in the coil. Because vibrations vary widely in frequency and amplitude, it is difficult to design a vibrational energy harvester with wide applicability. In addition, some vibrational energy harvesters are also used for damping, which is difficult to optimize with respect to harvesting energy. For example, when energy harvesting is maximized, damping is minimized, and vice versa.

Accordingly, there exists a need for a chaotic vibration energy harvester and a method for controlling such a harvester.

### SUMMARY

A chaotic vibration energy harvester includes a body forming a fluid chamber. At least one coil surrounds at least a portion of the fluid chamber. A ferromagnetic fluid is located within the fluid chamber. The ferromagnetic fluid occupies less than an entirety of the fluid chamber such that the ferromagnetic fluid forms a free floating mass that moves within the fluid chamber relative to the at least one coil. Movement of the body causes movement of the ferromagnetic fluid relative to the at least one coil, which changes magnetic flux within a volume surrounded by the at least one coil and induces a current in the at least one coil.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a perspective view of a chaotic vibration energy harvester according to an embodiment of the subject matter described herein;

FIG. 2 is a schematic diagram of a chaotic vibration energy harvester according to an embodiment of the subject matter described herein;

FIG. 3 is a block diagram of a control system for a chaotic vibration energy harvester according to an embodiment of the subject matter described herein; and

FIG. 4 is a flow chart illustrating exemplary steps for chaotic vibration energy harvesting according to an embodiment of the subject matter described herein.

### DETAILED DESCRIPTION

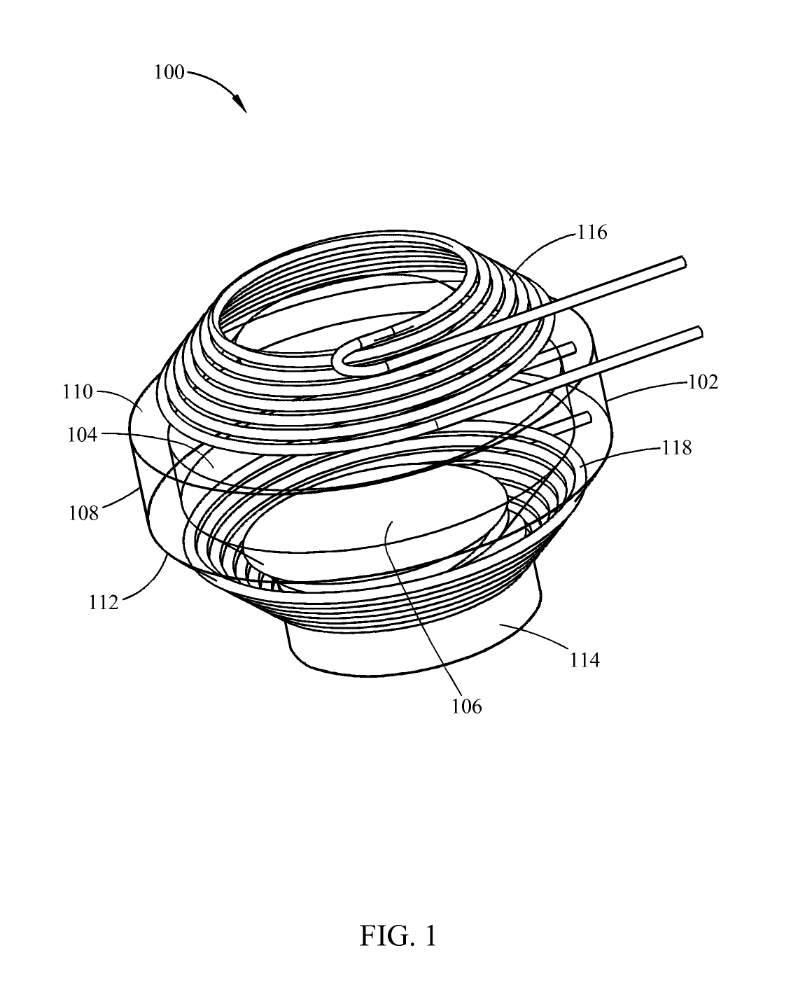

A chaotic vibration energy harvester for harvesting vibrational energy is disclosed. FIG. 1 illustrates an example of a chaotic vibration energy harvester according to an embodiment of the subject matter described herein. Referring to FIG. 1, energy harvester 100 includes a body 102 that defines a chamber 104. Chamber 104 is configured to hold a ferromagnetic fluid 106. In the illustrated example, body 102 includes a cylindrical portion 108 and conic portions 110 and 112. Body 102 may rigid or flexible. In one example, body 102 may comprise a fiberglass or carbon fiber material. Movement of body 102 may cause fluid 106 to move relative to coils 116 and 118. Such movement induces a current in coils 116 and 118. Ferromagnetic fluid 106 may be any suitable fluid with ferromagnetic properties. A ferromagnetic nanofluid suitable for use with embodiments of the subject matter described herein may include ferromagnetic nanoparticles suspended in a synthetic oil. The nanoparticles may range in size from 1 nanometer to tens of nanometers. In one example, ferromagnetic fluid 106 comprises a ferromagnetic nanofluid, such as any of the EFH series of ferrofluids available from Ferrotech Corporation of New Castle, Pa.

In the illustrated example, chamber 104 holds a volume of ferromagnetic fluid 106 that is less than the entire volume of chamber 104, with the remainder of the volume being filled with a gas, such as air. In one example, the percentage of the volume of chamber 104 occupied by fluid 106 may range from about 10% to about 20%. By occupying less than an entirety of fluid chamber 104, ferromagnetic fluid 106 forms a free floating mass within fluid chamber 104.

A permanent magnet 114 may be positioned near either or both ends of harvester 100 to provide a magnetic bias flux. When ferromagnetic fluid 106 moves relative to coils 116 and 118 or vice versa, the magnetic flux in the area surrounded by coils 116 and 118 changes. The change in magnetic flux induces a current in each of coils 116 and 118 and can be collected by an energy harvesting system (not shown in FIG. 1). In one exemplary system, coils 116 and 118 each included about 2,000 turns and produced an AC voltage of about 1 mV. The number of turns in coils 116 and 118 may be adjusted according to desired output voltage.

It should be noted that in the embodiments described herein, ferromagnetic fluid 106 functions as the sole flux change inducing agent within coils 116 and 118. That is, a solid permanent magnet that moves within the regions surrounded by coils 116 and 118 is not needed. As a result of using a free floating fluid mass instead of a moving solid magnet to induce flux change, the durability, flexibility, and vibrational frequency range of operation of chaotic vibration energy harvester 100 may be increased over systems that rely on moving solid permanent magnets.

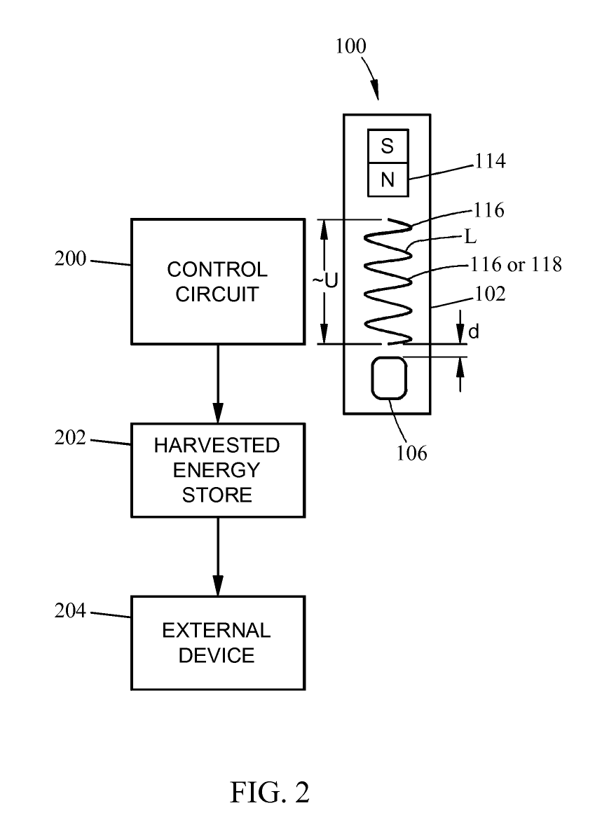

FIG. 2 is a schematic diagram of chaotic vibration energy harvester 100 and an associated control system and external device. Referring to FIG. 2, permanent magnet 114 is located near coil 116 or 118. Ferromagnetic nanofluid 106 moves when harvester 100 vibrates, inducing a change in magnetic flux in the area surrounded by coils 116 and 118. The change in magnetic flux induces a current in coil 116 and/or 118. The current may be harvested and used to power an external system. In particular, control circuit 200 controls a DC bias voltage U applied to coil 116 or 118 to increase or decrease the damping performed by chaotic vibration energy harvester 100. For example, to increase the damping performed by chaotic vibration energy harvester 100, control circuit 200 may increase a DC bias voltage applied to coil 116 or 118. To decrease the amount of damping performed by chaotic vibration energy harvester, control circuit 200 may decrease the DC bias voltage U applied to coil 116 or 118.

Control circuit 200 also controls the amount of energy harvested from coils 116 or 118. Energy store 202 stores harvested energy. An external device 204, such as a sensor or other device, can be powered using the harvested energy. Damping performed by chaotic vibration energy harvester 100 may also be controlled by controlling the level of energy harvested from energy harvester 100. For example, to increase the damping, the amount of energy harvested from chaotic vibration energy harvester 100 may be decreased. To decrease the damping, the amount of energy harvested from chaotic vibration energy harvester 100 may be increased.

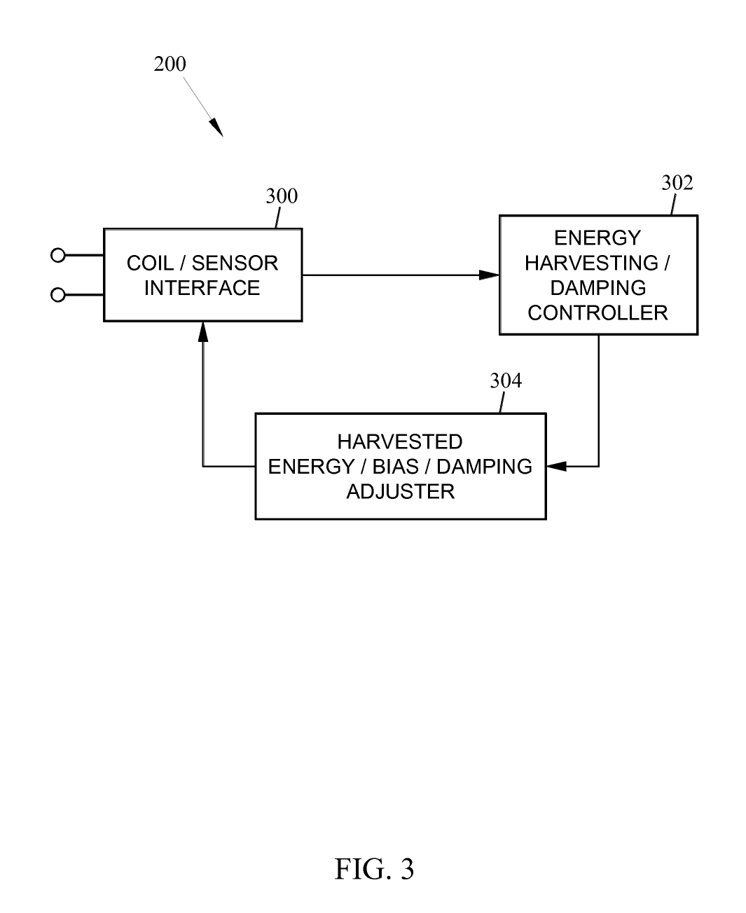

FIG. 3 is a block diagram of control system for controlling energy harvesting and damping of chaotic vibrational energy harvester 100. Referring to FIG. 3, a coil/sensor interface 300 interfaces with coils 116 and 118 and with a force sensor that senses damping performed by harvester 100. Coil/sensor interface 300 may include wires that connect to the corresponding leads on coils 116 and 118 and on the force sensor. An energy harvesting/damping controller 302 receives the output from coil/sensor interface 300 and outputs a signal indicative of the difference between desired and actual levels. If the harvested energy and damping are both at desired levels, the signal output by controller 302 may cause harvested energy/bias/damping adjuster 304 to continue harvesting energy at the current level. If either the damping or the energy harvesting is not at the desired level, controller 302 may output a signal that instructs adjuster 304 to adjust the level of energy harvesting, the level of damping, or the DC bias. For example, if stiff or increased damping is required, energy harvesting and damping controller 302 may instruct adjuster 304 to reduce the amount of energy being harvested and thus increase the damping of the system. On the other hand, if the damping of the system is too high, energy harvesting and damping controller 302 may instruct adjuster 304 increase the amount of energy being harvested to decrease the damping of the system.

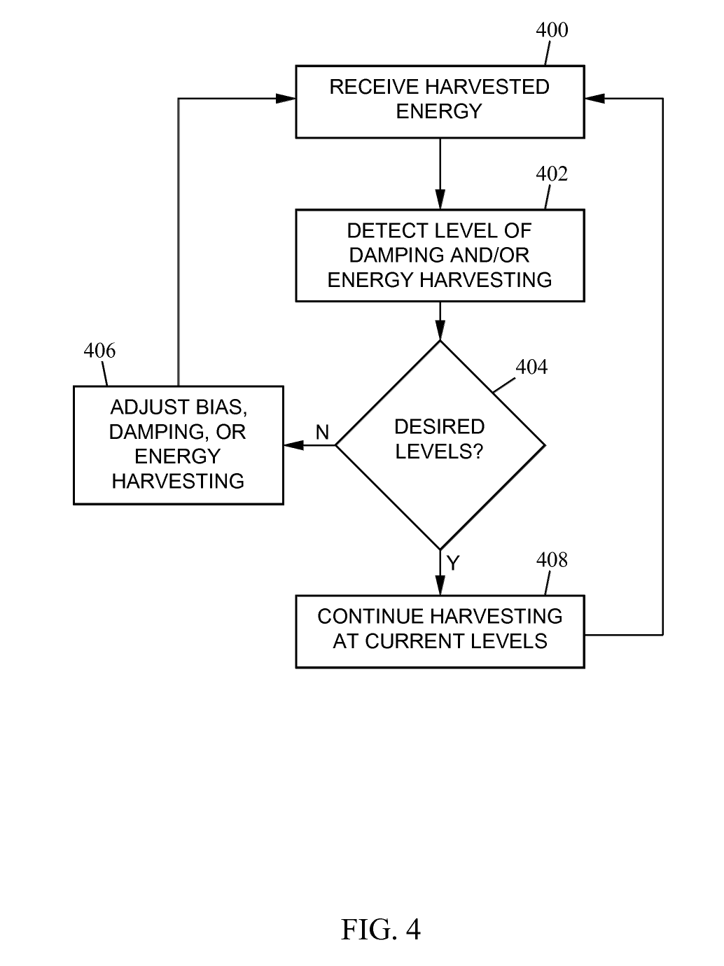

FIG. 4 is a flow chart illustrating exemplary steps for controlling energy harvesting by a vibration energy harvester according to an embodiment of the subject matter described herein. Referring to FIG. 4, in step 400, harvested energy is received. For example, harvester 100 may generate current in coils 116 and 118, which is received by coil/sensor interface 300. In step 402, the level of damping and/or energy harvesting is determined. In step 406, it is determined whether the damping and/or energy being harvested are at desired levels. For example, energy harvesting/damping controller 302 may determine a difference between desired damping and/or energy harvesting levels and actual levels. In step 408, if it is determined that the level of damping and/or energy harvesting are not at desired levels, the bias, harvesting, and/or damping are adjusted. For example, energy harvesting/damping controller 302 may output a signal that indicates the difference between desired and actual levels, and adjuster may make the necessary adjustment to harvesting or bias voltage to minimize the difference. Control then returns to step 400. In step 406, if it is determined that the harvesting and/or damping are at desired levels, control proceeds to step 410 where harvesting is continued at the current level. Control then returns to step 400.

It will be understood that various details of the subject matter described herein may be changed without departing from the scope of the subject matter described herein. Furthermore, the foregoing description is for the purpose of illustration only, and not for the purpose of limitation.

1. A chaotic vibration energy harvester comprising:
a body forming a fluid chamber;
at least one coil surrounding at least a portion of the fluid chamber; and
a ferromagnetic fluid located in the fluid chamber and occupying less than an entirety of the fluid chamber such that the ferromagnetic fluid forms a free floating mass that moves within the fluid chamber relative to the at least one coil, wherein movement of the body causes movement of the free floating mass of ferromagnetic fluid relative to the at least one coil, which changes magnetic flux within a volume surrounded by the at least one coil, and induces a current in the at least one coil.

2. The chaotic vibration energy of claim 1 wherein the body includes a cylindrical portion sandwiched between conic portions.

3. The chaotic vibration harvester of claim 1 wherein a remainder of the chamber that is not occupied by the ferromagnetic fluid occupied by a gas medium.

4. The chaotic vibration harvester of claim 3 wherein the gas comprises air.

5. The chaotic vibration harvester of claim 2 wherein the at least one coil comprises first and second coils respectively positioned on the conic portions of the body.

6. The chaotic vibration energy harvester of claim 1 comprising a permanent magnet coupled to the body for generating magnetic flux.

7. The chaotic vibration harvester of claim 6 wherein the ferromagnetic fluid comprises a ferromagnetic nanofluid.

8. The chaotic vibration energy harvester of claim 7 wherein the ferromagnetic nanofluid comprises a synthetic oil having ferromagnetic particles suspended in the oil.

9. The chaotic vibration energy harvester of claim 1 comprising a control system to the at least one coil for harvesting energy from the coil.

10. The chaotic vibration energy harvester of claim 9 wherein the control system varies the amount of energy harvested by the coil based on a desired amount of damping required by the chaotic vibration energy harvester.

11. The chaotic vibration energy harvester of claim 1 wherein the ferromagnetic fluid occupies a volume of the fluid chamber that is equal to a value within a range of about 10% of the volume of the fluid chamber to no more than 20% of the volume of the fluid chamber.

12. A method for controlling a chaotic vibration energy harvester comprising:
receiving harvested energy from a chaotic vibration energy harvester comprising a body forming a chamber at least one coil, and a ferromagnetic fluid located in the chamber in a region surrounded by the at least one coil, wherein the ferromagnetic fluid occupies less than an entire volume of the chamber such that the ferromagnetic fluid forms a free floating mass that moves within the fluid chamber relative to the at least one coil, wherein movement of the body causes movement of the mass of ferromagnetic fluid relative to the at least one coil, which induces a current in the at least one coil;
determining whether a level of damping or energy harvesting by the chaotic vibration energy harvester chaotic vibration energy is equal to a desired level; and
in response to determining that the level of damping or energy harvesting is not at a desired level, adjusting a bias voltage applied to the at least one coil, a level of damping, or a level of energy harvesting.

13. The method of claim 12 wherein the body includes a cylindrical portion sandwiched between conic portions.

14. The method of claim 12 wherein a remainder of the chamber is not occupied by the ferromagnetic fluid occupied by a gas.

15. The method of claim 14 wherein the gas comprises air.

16. The method of claim 13 wherein the at least one coil comprises first and second coils respectively positioned on the conic portions of the body.

17. The method of claim 12 comprising a permanent magnet coupled to the body for generating magnetic flux.

18. The method of claim 12 wherein the ferromagnetic fluid comprises a ferromagnetic nanofluid.

19. The method of claim 18 wherein the ferromagnetic nanofluid comprises a synthetic oil having ferromagnetic particles suspended in the oil.

20. The method of claim 12 comprising a control system coupled to the at least one coil for harvesting energy from the at least one coil.

21. The method of claim 20 wherein the control system varies the amount of energy harvested by the coil based on a desired amount of damping required by the chaotic vibration energy harvester.

22. The method of claim 12 wherein the ferromagnetic fluid occupies a volume of the fluid chamber that is equal to a value within a range of about 10% of the volume of the fluid chamber to no more than 20% of the volume of the fluid chamber.

23. A non-transitory computer readable medium having stored thereon executable instructions that when executed by the processor of a computer controlled the computer to performs steps comprising:
receiving harvested energy from a chaotic vibration energy harvester comprising a body forming a chamber at least one coil, and a ferromagnetic fluid located in the chamber in a region surrounded by the at least one coil, wherein the ferromagnetic fluid occupies less than an entire volume of the chamber such that the ferromagnetic fluid forms a free floating mass that moves within the fluid chamber relative to the at least one coil, wherein movement of body causes movement of the ferromagnetic fluid relative to the at least one coil, which induces a current in the at least one coil;
determining whether a level of damping or energy harvesting by the chaotic vibration energy harvester chaotic vibration energy is equal to a desired level; and
in response to determining that the level of damping or energy harvesting is not at a desired level, adjusting a bias voltage applied to the at least one coil, a level of damping, or a level of energy harvesting.
